(19) United States
(12) Patent Application Publication
(10) Pub. No.: US 2020/0167759 A1
(43) Pub. Date: May 28, 2020

(54) Parking Lot Check In System

(71) Applicant: FlexePark, LLC, Indianapolis, IN (US)

(72) Inventors: Michael Dowden, Brownsburg, IN (US); Martine Dowden, Brownsburg, IN (US); Marc Ebtinger, Brownsburg, IN (US); James Handshoe, Brownsburg, IN (US); Michael McGinnis, Brownsburg, IN (US)

(21) Appl. No.: 16/695,176

(22) Filed: Nov. 25, 2019

Related U.S. Application Data
(60) Provisional application No. 62/771,042, filed on Nov. 24, 2018.

(51) Int. Cl. G06Q 20/32; G06K 7/14

(52) U.S. Cl. CPC G06Q 20/325; G06Q 2240/00; G06K 7/1417

(57) ABSTRACT

A system for operating a location for parking vehicles in a manner which is easy to implement and requires little or no equipment at the location. Access to the system would be through mobile devices which are widely available. Information about the location at issue would be accessed via a QR Code (or similar means) and data collection would preferably be done by data extraction from videos or pictures. Payment for the services would be by digital means through the system. The system would also provide the owner or manager of the location the means to monitor and/or enforce violations of the location restrictions.

### CROSS-REFERENCE TO RELATED APPLICATIONS

Not applicable.

### STATEMENT REGARDING FEDERAL SPONSORED RESEARCH OR DEV

Not applicable.

### FIELD OF THE DISCLOSURE

The present disclosure relates to a system for managing, monitoring and assessing a fee for parking a vehicle in a paid parking location and, additionally, to a system of determining if a vehicle is in violation of the requirements for use of the parking location.

### BACKGROUND OF THE INVENTION

Parking of motor vehicles in congested areas is something that has caused problems as long as vehicles have multiplied to the point that they are significant in number. Traditionally, this has been addressed by having privately owned locations that were designated for parking-purposes only. Historically, as for these kinds of locations, there are two traditional systems for monetizing the availability of parking spaces. The first of these was the parking meter, which users would insert funds for a certain period of time in order to use a parking space. The downside to these systems is that they required significant capital expenditure in putting the meters in to each space and then maintaining and operating the meter devices themselves. Also, enforcement is expensive and is labor intensive, as there is generally no remote monitoring available and thus needs to be provided by police (if the lot or space is connected to a municipality) or private individuals. The other traditional system is that of having a monitored lot or spaces, which require a person or persons to monitor the activity of the lot, deal with customers and provide enforcement. However, this system is expensive and troublesome in that it requires staff in order to operate the system. Further, there may be lots or areas that are used for different purposes during the day (such as office parking) that could be made available after day-time hours, if there was means to monitor the activity and monetize these spaces. More modern approaches have attempted to overcome the difficulties of the traditional versions and the multi-use lots, however, there is still a need for a modern and efficient parking lot check-in system, which the disclosed invention will provide.

### BRIEF SUMMARY OF THE INVENTION

This invention offers the ability for users to check-in to parking lots and to pay for parking using their mobile phone, using a unique system to address the inefficiencies of other previous systems. One of those inefficiencies is the need for extensive hardware. This system requires no equipment for the preferred embodiment and could also be used, if necessary, with minimal equipment (a minimum of one camera) at the location. This fact makes this invention much easier to implement and use than previous systems. Also, instead of using a kiosk or other means for users to interact with the system or provide inputs, all the input received from users, can be obtained through readily available mobile devices, including phones, tablets, laptops, or similar devices. Further, the preferred embodiment also incorporates the use of QR codes, which will direct a user to a unique URL, and extraction of data from video and pictures to ease access to the system and to also streamline data input by users of the system.

In summary, a user would find a location which was using the disclosed invention and they would either pull up the application, or the website with the system software, using their mobile device, or use the camera on their mobile device camera, to access a QR code that would be mounted at the location, which would direct the user to a unique URL. In either instance, they would check-in using the system, provide vehicle data (either manually, through extraction of data from images or associated account information) and would arrange payment for the selected location and in the quantity desired. Likewise, the manager or owner of the location would use the system (either remotely or on-site) to monitor activity at the location and could, if remote, use cameras installed at the location to automatically track vehicle and use data for the location. Additionally, enforcement by the manager or owner could be provided via the use data in conjunction with the payment data to determine if any vehicles were in violation. As for those violations, the system could alert the manager or owner (or third-parties) of action that needed to be taken.

The above summary is not intended to describe each illustrated embodiment or every implementation of the present invention. The detailed description that follows more particularly exemplify these embodiments.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying figures, where:

FIG. 1 is a diagrammatical illustration of one embodiment of the check-in portion of the disclosed invention.

FIG. 2 is a schematic illustration of the process associated with one embodiment as seen from a potential customer.

### DESCRIPTION

For the purpose of promoting an understanding of the principles of the present invention, reference will now be made to the embodiment illustrated in specific language contained herein. It will, nevertheless, be understood that no limitation of the scope of the invention is thereby intended; any alterations and further modifications of the described or illustrated embodiments and any further applications of the principles of the invention as illustrated therein are contemplated as would normally occur to one skilled in the art to which the invention relates.

The preferred embodiment of the system in this disclosure would be one that incorporates both the use of data extraction from photographs and videos, as well the liberal use of QR Codes (or similar codes), which would direct a user to a unique URL, to ease interaction with the system.

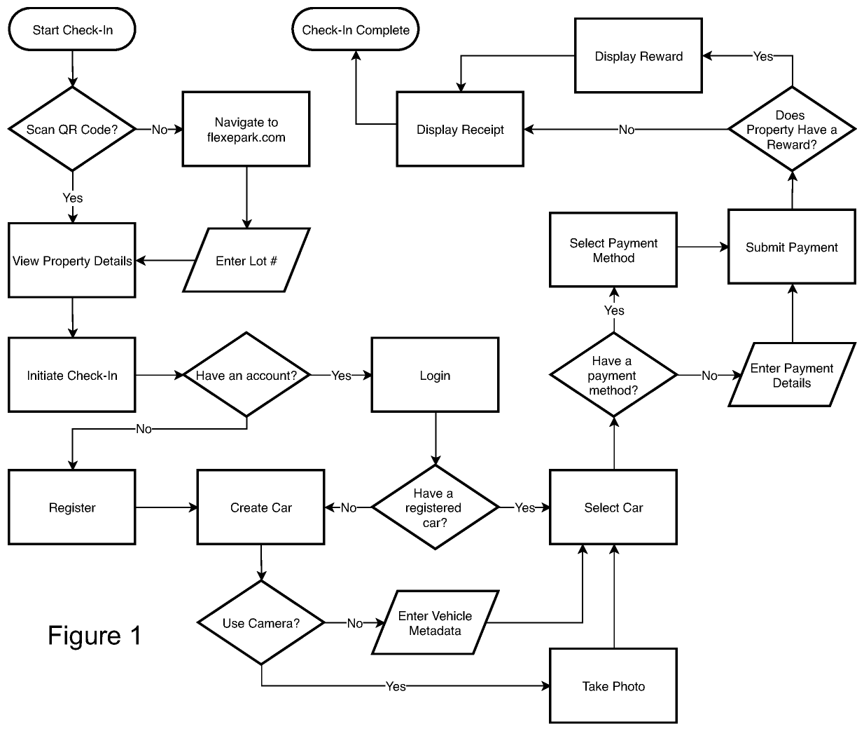

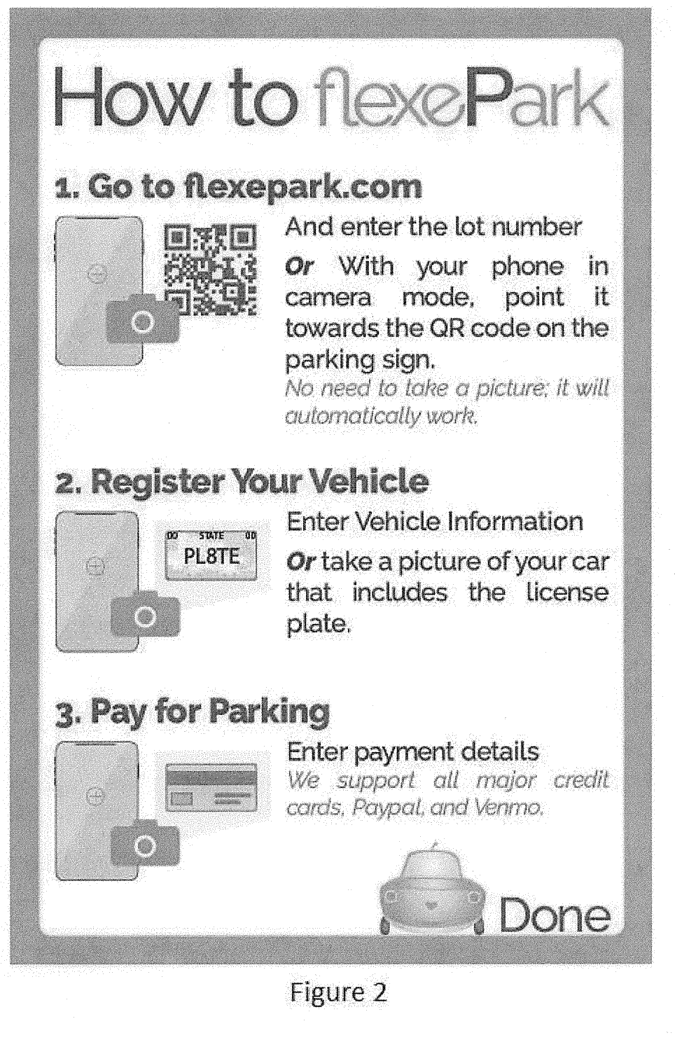

In the preferred embodiment, after a customer parks their car in a location equipped with this system, the customer has two options to begin the check-in process with the first being to navigate to an assigned URL or web address (i.e. https://flexepark.com) using a standard web browser on their mobile phone, laptop or other device that can reach the internet. See FIG. 1. They then enter the code shown on a sign placed at the location. See FIG. 2.

The second way is to scan the QR code shown on the same parking sign that included the code indicated above, using a dedicated QR scanner app or the built-in camera app on their mobile phone or other device. See FIG. 2. Either of these options will take the customer to a unique URL page which represents the location in which they are parking, effectively mapping the physical location to a digital representation.

The customer would then sign-in to the system using an email address & password, or an existing social media or similar account, such as Facebook or Google account. Once signed-in the customer would register the vehicle being parked or, if they have an account already, access a previously saved vehicle. See FIG. 1.

In the event the vehicle is not in the system, there are multiple ways the vehicle could be added to the system, with the preferred embodiment being that relevant information about the vehicle (make, color, model, license plate number and state) is extracted from videos or photographs of the vehicle taken by the user using a mobile device. In an additional embodiment, this information would be put in the system by manually typing in the information using the customer's mobile device.

Once the customer has selected the location and the vehicle they would then, in the event that the location charges by time or some other metric (versus a flat fee), select the amount of parking desired (i.e. 4 hours). The amount due from the customer would then be calculated by the system and the final step would be to have the customer pay for their parking using a digital payment method such as PayPal, Credit Card, or device-specific billing account (such as Apple Pay or Google Pay). Upon completing payment, the customer would receive an electronic confirmation.

In an additional embodiment, upon completion of the transaction, the customer would be eligible for some type of reward (which may be a coupon or other incentive) as determined by the owner of the location.

Another embodiment would be for second or subsequent users, where the user can pull up historical information about locations they have used in the past, to speed the check-in process for subsequent parking. Additionally, the vehicle associated with the user can be maintained, so that subsequent uses would eliminate the need for putting in vehicle information. However, another embodiment would include the option for a user to put multiple vehicles into the account, so that they can simply select the vehicle being used on an occasion.

Enforcement as the use of the parking spaces can be provided manually, via web-enabled interface, whereby a manager or owner would have the ability to see all the customer at a location and can check the list of authorized customers with those present at the lot and can then provide enforcement measures, as necessary. In that case, then enforcement measures could be taken, including towing of the vehicle or ticketing the vehicle. A ticket could also be issued to a customer if they already have an account in the system.

The unique features of the system, include, but are not limited to the fact that each parking location is represented by a unique URL, which may be represented using the industry-standard QR code; the system may be loaded on any mobile phone or other web-enabled device, using a standard web browser, by scanning the QR code or navigating to the URL associated with the location; the vehicles may be registered with the application by taking a photo of the vehicle with a mobile phone, whereby the information about the vehicle (make, model, color), license plate, etc., are automatically identified via the photograph; historical information about location usage and vehicles is automatically maintained; streamlined or automated enforcement; and rewards may be granted to a customer anytime they park in a participating location.

The system is claimed as follows:

1. A system for operating a parking location comprising an electronic means to store and manipulate data which allows customers to park a vehicle at a certain location and to store the information about the interaction for future use and further configured to:
(a) allow a customer to access information about the location through a QR Code associated with the location using their mobile device;
(b) a means to determine customer information;
(c) once customer information is obtained, having a means for the customer to select an appropriate vehicle;
(d) a means to have the customer select the digital payment method and to make the payment;
(e) a means to generate confirmation of payment to customer; and
(f) a means to determine if additional action is necessary.

2. A system of claim 1, wherein the means to determine customer information is through the use of an established account where the customer information has been stored by the system.

3. A system of claim 1, wherein the means to determine customer information is to determine if they have an existing account and if they do not, then initiating data collection from the customer to establish an account.

4. A system of claim 1, wherein the means for the customer to select an appropriate vehicle is by associating a vehicle with the customer where the data about the vehicle, including make, model, color, license plate number and state, are extracted by the system from video(s) or picture(s) of the vehicle, which information is then saved and associated with the customer.

5. A system of claim 1, wherein the means for the customer to select an appropriate vehicle is by selecting a vehicle already associated with the customer.

6. A system of claim 1, wherein the means for the customer to select an appropriate vehicle is by manually inputting into the system the information about the vehicle, which information is then saved and associated with the customer.

7. A system of claim 1, wherein the means for determining if additional action is necessary is whether or not the location has a reward or other system in place that requires notification of the reward or benefit being transmitted to customer.

8. A system for operating a parking location comprising an electronic means to store and manipulate data which allows customers to park a vehicle at a certain location and to store the information about the interaction for future use and further configured to:
(a) allow a customer to access information about the location by manually inputting a location identifier into the system using their mobile device;
(b) a means to determine customer information;
(c) once customer information is obtained, having a means for the customer to select an appropriate vehicle;
(d) a means to have the customer select the digital payment method and to make the payment;
(e) a means to generate confirmation of payment to customer; and
(f) a means to determine if additional action is necessary.

9. A system of claim 8, wherein the means to determine customer information is through the use of an established account where the customer information has been stored by the system.

10. A system of claim 8, wherein the means to determine customer information is to determine if they have an existing account and if they do not, then initiating data collection from the customer to establish an account.

11. A system of claim 8, wherein the means for the customer to select an appropriate vehicle is by associating a vehicle with the customer where the data about the vehicle, including make, model, color, license plate number and state, are extracted by the system from video(s) or picture(s) of the vehicle, which information is then saved and associated with the customer.

12. A system of claim 8, wherein the means for the customer to select an appropriate vehicle is by selecting a vehicle already associated with the customer.

13. A system of claim 8, wherein the means for the customer to select an appropriate vehicle is by manually inputting into the system the information about the vehicle, which information is then saved and associated with the customer.

14. A system of claim 8, wherein the means for determining if additional action is necessary is whether or not the location has a reward or other system in place that requires notification of the reward or benefit being transmitted to customer.

15. A system for operating a parking location comprising an electronic means to store and manipulate data which allows customers to park a vehicle at a certain location and to store the information about the interaction for future use and further configured to:
(a) use a video camera mounted at the location to extract data from images taken at the location of vehicles using the location;
(b) use the vehicle information to automatically determine whether the vehicle is associated with a previously registered customer;
(c) if associated with a previously registered customer, automatically send the customer the required payment information for the use of the location, send a payment confirmation and take additional actions, if needed; and
(d) if not associated with a previously registered customer or in violation of the restrictions for the location, determine if additional actions need to be taken.

16. A system of claim 15, wherein the means for determining if additional action is necessary is whether or not the location seeks to take enforcement or other action for improper use of the location and to prompt such action, such as towing, ticketing or booting of vehicles.

17. A system of claim 15, wherein the means for determining if additional action is necessary is whether or not the location has a reward or other system in place that requires notification of the reward or benefit being transmitted to customer.
